(19) United States
(12) Patent Application Publication
(10) Pub. No.: US 2008/0228690 A1
(43) Pub. Date: Sep. 18, 2008

(54) System and method for calculating a metric of a sub-transaction on an IP network

(76) Inventor: Yair Horovitz, Mazkeret Batya (IL)

Correspondence Address: Pearl Cohen Zedek Latzer, LLP, 1500 Broadway, 12th Floor, New York, NY, 10036, US

(21) Appl. No.: 11/724,229

(22) Filed: Mar. 15, 2007

(51) Int. Cl. G06N 5/02

(52) U.S. Cl. 706/48

(57) ABSTRACT

A system and method of calculating a metric for a sub-transaction that is included in a transaction on an IP network.

### FIELD OF THE INVENTION

The present invention generally relates to network applications. More particularly, the present invention relates to a system and method for calculating a metric of a sub-transaction of a transaction on an IP network.

### BACKGROUND OF THE INVENTION

Existing tools provide lists and hierarchies of commands, transactions and other messages transferred over a network, such as data or signals between two or more nodes or points of an IP network. Such messages may be grouped into transactions. For example, a transaction may be composed of a group of messages, commands or functions initiated by a user for receiving a service, data, an image, or a collection of images such as those in a web-page. The hierarchical structure of the transaction may be composed of transactional components, comprising sub-groups or sub-transactions. For example, if a transaction may include a request for a web-page, a sub-transaction may include a request for a component of the web-page such as an image that may appear in the web-page, where such sub-transaction may have been spawned or generated by the transaction.

### SUMMARY OF THE INVENTION

In some embodiments, a method of the invention may include accepting an indication of a transaction on an IP network, where the transaction includes a sub-transaction; and calculating a metric for the sub-transaction. In some embodiments, the transaction may include a first hierarchical level transaction, and the sub-transaction may include a second hierarchical level transaction, and the method may include calculating the metric for the second hierarchical level transaction and comparing the calculated metric for the second hierarchical level with the metric for the transaction on the first hierarchical level. In some embodiments, the transaction may include a sub-sub-transaction, and the calculating may include calculating the metric for the sub-sub-transaction.

In some embodiments, the method may present an indication of the sub-transaction and an indication of the metric in a hierarchical format, such as for example in a tree format.

In some embodiments, a method may include ordering the indication of the sub-transactions by a result of the calculated metric.

In some embodiments, a method may include plotting the metric for more than one sub-transaction; and displaying a graph of the plotted metric.

In some embodiments, the metric may include a response time of the sub-transaction, a network time of the sub-transaction, a server time of the sub-transaction, a client time of the sub-transaction, errors in the sub-transaction, a size in bytes of the sub-transaction, a number of downloaded bytes in the sub-transaction, a number of uploaded bytes in the sub-transaction, a number of retransmissions of the sub-transaction, a number of packets in flight, an average TCP window size, a number of zero TCP window events and an average packet size in the sub-transaction.

In some embodiments a method may include altering a condition of the IP network from a first condition to a second condition; and comparing the metric for the sub-transaction under the first condition to the metric for the sub-transaction on the second condition. In some embodiments, the metric may be calculated for more than one element of the IP network.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a conceptual illustration of end points connected to an IP network, in accordance with a preferred embodiment of the present invention;

FIG. 2 is a depiction of a list of exchanges between points on an IP network in accordance with an embodiment of the invention; and

FIG. 3 is a flow diagram of a method in accordance with an embodiment of the invention.

### DETAILED DESCRIPTION OF THE PREFERRED EMBODIMENTS

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well-known features may be omitted or simplified in order not to obscure embodiments of the invention described herein.

Unless specifically stated otherwise, as apparent from the following discussions, it is appreciated that throughout the specification, discussions utilizing terms such as “selecting,” “evaluating,” “processing,” “computing,” “calculating,” “determining,” “designating,” “allocating” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. In some embodiments, a series of instructions are included in an article such as a memory device, such that upon the execution of such instructions by for example a processor, a method of the invention may be practiced.

In addition to its meaning in the art, the term “message” may include a command, a signal, a function, data or any other form of information transferred over the network in a course of a network transaction such as for example a transaction on an IP network.

In addition to its meaning in the art, the term “transaction” may include a command, signal, function or request that may be generated by for example a user or client or other element that may be connected to an IP network, where such transaction may request or respond to a message, service or other signal between one or more components on the IP network.

In addition to its meaning in the art, the term “transactional component” may include the whole transaction or one or more sub-transactions that may include a message initiated by the transaction.

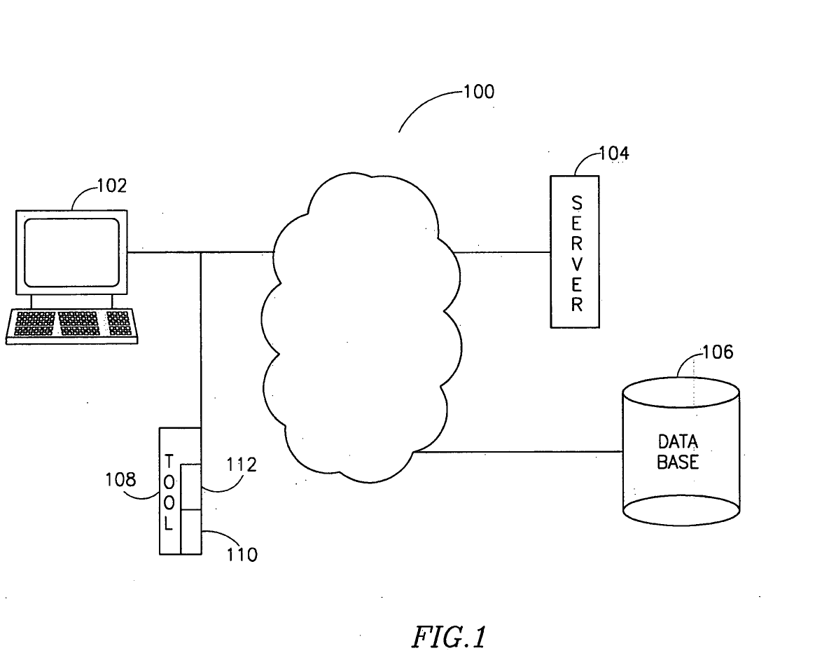

Reference is made to FIG. 1, a conceptual illustration of end points connected to an IP network, in accordance with a preferred embodiment of the present invention. In some embodiments, an end-point or node of an IP network 100, may include one or more clients 102 that may be connected to IP network 100, and one or more servers 104, data bases 106 or other components or sources of computing power or data that may also be connected to IP network 100. In some embodiments, IP network 100 may be or include a wide area network such as the Internet, a local area network (LAN), a combination of a LAN that is connected to a WAN, or another IP network. In some embodiments, IP network 100 may be or include a virtual, emulated or simulated network. In some embodiments, client 102 may be or include a computer, work station, Internet telephone or other electronic device suitable to connect to IP network 100 and to receive or respond to commands from other points on IP network 100.

In some embodiments, a tool or device 108 may be connected to for example IP network 100 and to client 102. Device 108 may include a processor 110, such as for example a central processing unit, and a memory 112, such as for example, a hard drive, flash memory or other mass data storage unit. In some embodiments, device 108 may include software or other instructions that may collect or record a series of exchanges, commands or functions that may be performed by client 102 and/or for example one or more servers 104. In some embodiments, device 108 may record or measure a characteristic or metrics about a transaction, sub-transaction, message, data, packet or other flow of information to or from a client 102 or other point or node on IP network 100.

In operation, an embodiment of the invention may accept data about a transaction executed over an IP network, such as for example a GET function that may be requested by a client 102 of IP network 100. The transaction may generate, spawn or cause one or more sub-transactions that may for example be part of a completion of the transaction. A device 108 may record or monitor one or more of such sub-transactions and may measure a characteristic or metric of one or more sub-transactions. In some embodiments, such sub-transactions may be categorized into hierarchical levels, and metrics of all or some of the sub-transactions on a particular hierarchical level may be aggregated. One or more sub-transactions may include or generate one or more sub-sub-transactions, which may constitute a further hierarchical level, and metrics may be collected for such sub-sub-transactions on such further hierarchical level.

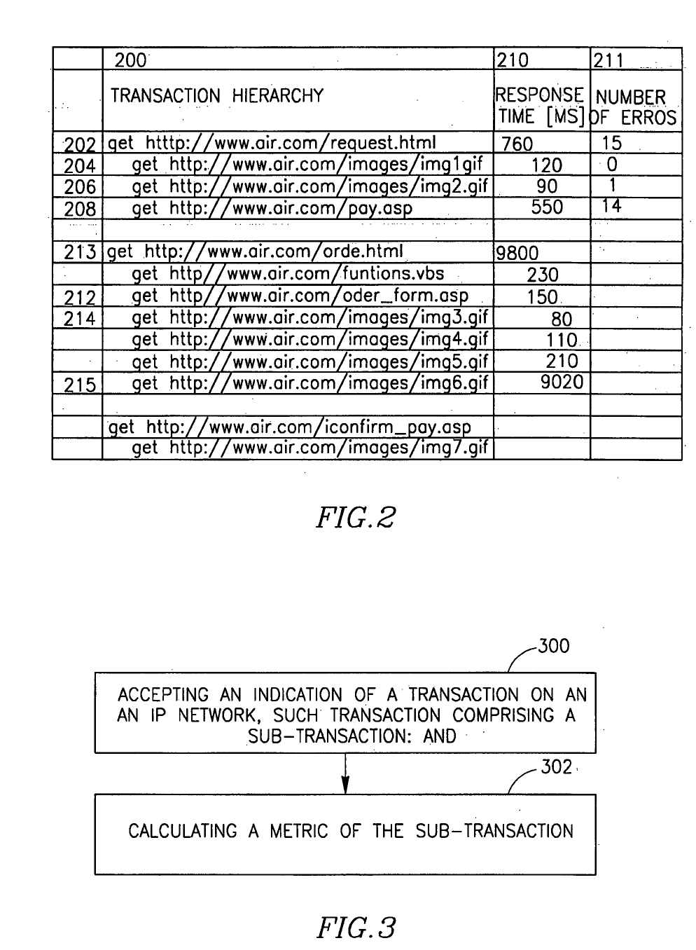

Reference is made to FIG. 2, a list of exchanges or transactions between points on an IP network, in accordance with an embodiment of the invention. Table 200 may include a list of functions or commands that may have been recorded by for example tool 108 as having been issued or received by for example a client in a particular time period. The recorded list may include transactions such as get commands, or other functions that may have been requested by the client 102. In some embodiments, one or more of the exchanges or sub-transactions that are associated with or are part of one or more transactions, functions or commands in table 200 may be recorded or analyzed, and one or more metrics of such sub-transaction may be collected.

For example in a first GET transaction 202, a client 102 may request to receive a web page that includes for example two images and a set of data about air fares. The GET transaction 202 may generate three sub-transactions 204, 206, and 208. Transaction 202 may be considered a first hierarchical level, and the three sub-transactions 204, 206 and 208 may be considered to be part of a second hierarchical level, as they may have been generated for example by transaction 202. In some embodiments, a metric such as response time 210 or number of errors 211 may be collected by for example device 108 for one or more of transaction 202 and sub-transactions 204, 206, 208. In some embodiments such metrics for sub-transactions may be aggregated by hierarchical level. In some embodiments, the presentation of metrics for one or more sub-transactions may assist a programmer, network manager or other analyst in determining the particular part of a larger transaction that is generating a particular characteristic of the transaction. For example, an analyst may discern that transaction 202 is generating a large number of errors, but instead of looking for or correcting a condition in each sub-transaction 204, 206 and 208, the analyst may be presented with an indication that most of the errors are being generated by sub-transaction 208, and that error correction would be most productively directed at sub-transaction 208.

Some transactions may generate more than one hierarchical level of sub-transactions, such as one or more sub-transactions and one or more sub-sub transactions. For example, transaction 213 may generate sub-transaction 212, which may in turn generate sub-sub-transaction 214. Sub-transaction 212 may be deemed a second hierarchical level, and sub-sub-transaction 214 may be deemed a third hierarchical level. Other designations may be used. In some embodiments, a device 108 may collect metrics or measurements about one or more of the sub-transactions or sub-sub-transactions, and may present such metrics. For example, an analyst may be presented with a total response time 210 for transaction 213 that indicates a relatively long response time for the execution of the transaction. A first analysis may lead one to believe that the large number of images being retrieved as part of the transaction may be causing the long response time. However, an embodiment of the invention may present data that indicates that most of the response time is taken by a single function such as a retrieval of the last image in the web-page i.e. sub-transaction 215. An analyst may therefore concentrate efforts on rectifying or replacing the particular image or sub-sub-transaction that accounts for the large response time.

In some embodiments, a metric or measurement may be aggregated to include the characteristics of one, some or all of the sub-transactions in a particular transaction hierarchy level.

In some embodiments, an indication of the characteristics or metrics concerning one or more of the sub-transactions or transaction hierarchical levels may be presented or displayed to for example a user on for example a screen or other display.

Reference is made to FIG. 3, a flow diagram of a method in accordance with an embodiment of the invention. In block 300, a device such as a network component or an element that may be connected to a client of an IP network, may accept for example a list or other indication of one or more transactions that may have been generated by for example a client on an IP network. In some embodiments, the transaction may include for example an indication of a hierarchical structure of the several component exchanges or sub-transactions that may have been generated or caused by a first transaction.

In block 302, a device or a processor connected to a network may calculate one or more metrics about one, some or all of the sub-transactions that may make up or be included in a transaction hierarchical level.

In some embodiments, hierarchical levels may be designated or assigned to levels of the sub-transactions and sub-sub transactions, and metrics may be calculated that aggregate or otherwise separate the metrics by levels. In some embodiments, one or more of the metrics or an indication of a metric such as a numeric or graphical representation of a metric may be displayed to a user. In some embodiments, such display may be in a tree format, where for example a sub-sub-transaction is displayed as underneath, indented or otherwise as derivative of a parent transaction.

In some embodiments, one or more transactions or sub-transactions may be identified as sub-transactions and ordered or otherwise displayed in ascending, descending or other order based on a result of the calculation of a metric.

In some embodiments, sub-transactions may be plotted or otherwise displayed on a graph that may show for example outlier transactions whose metrics are significantly greater than or aberrant of an expected metric for the transaction.

In some embodiments, a metric that may be collected or otherwise measured for one or more transactions or sub-transactions may be or include a response time of the sub-transaction, a network time of the sub-transaction, a server time of the sub-transaction, a client time of the sub-transaction, a number of errors of the sub-transaction, a size in bytes of the sub-transaction, a number of downloaded bytes in the sub-transaction, a number of uploaded bytes in the sub-transaction, a number of retransmissions of the sub-transaction that was required before the sub-transaction was completed, an average number of packets in flight in the sub-transaction, an average TCP window size in the sub-transaction and an average packet size in the sub-transaction. Other metrics may be calculated and displayed, such as in for example a ladder diagram. Other levels of sub transactions may be evaluated.

In some embodiments, a transaction or one or more sub-transactions may be executed over an IP network when for example the IP network is subject to a first set of conditions or constraints. The metrics or other characteristics of the transaction or sub-transactions may be collected and for example stored in for example a memory or displayed on for example a graph, chart or screen. The conditions or constraints to which the IP network may be subject may then be altered or modified and the same or similar set of transactions or sub-transactions may be executed. The same or similar metrics may be collected for the re-executed transactions or sub-transactions, and the differences between the metrics collected on the first set of transactions or sub-transactions may be compared to the metrics collected on the second set of transactions or sub-transactions that were executed on the altered IP network. In some embodiments a transaction or a parameter in a transaction may be altered and a comparison between the first and second transaction may be made.

In some embodiments, a metric may be calculated or collected for one or more elements of an IP network. For example, a measurement may be collected of the time that a packet is processed by a particular component of an IP network, or the amount of processing power or memory required to retrieve or process the data in a particular image called for by a particular processor. Other metrics may be used or evaluated.

It will be appreciated by persons skilled in the art that embodiments of the invention are not limited by what has been particularly shown and described hereinabove. Rather the scope of at least one embodiment of the invention is defined by the claims below.

I claim:

1. A method comprising:
accepting an indication of a transaction on an IP network, said transaction comprising a sub-transaction; and
calculating a metric of said sub-transaction.

2. The method as in claim 1, wherein said transaction comprises a transaction on a first hierarchical level, and wherein said sub-transaction comprises a sub-transaction on a second hierarchical level, and wherein said calculating comprises calculating said metric for said second hierarchical level and comparing said metric for said second hierarchical level with said metric for said transaction on said first hierarchical level.

3. The method as in claim 2, wherein sub-transaction comprises a sub-sub-transaction, and wherein said calculating comprises calculating said metric for said sub-sub-transaction.

4. The method as in claim 1, comprising presenting an indication of said sub-transaction and an indication of said metric in a hierarchical format.

5. The method as in claim 4, comprising presenting said indication in a tree format.

6. The method as in claim 4, comprising ordering said indication of a plurality of said sub-transactions by a result of said calculating of said metric.

7. The method as in claim 1, comprising:
plotting said metric for a plurality of said sub-transactions; and
displaying a graph of said plotting.

8. The method as in claim 1, wherein said metric is selected from the group consisting of:
a response time of said sub-transaction;
a network time of said sub-transaction;
a server time of said sub-transaction;
a client time of said sub-transaction;
errors in said sub-transaction;
a size in bytes of said sub-transaction;
a number of downloaded bytes in said sub-transaction;
a number of uploaded bytes in said sub-transaction;
a number of packet in flight of said sub-transaction;
an average TCP window size in said sub-transaction
a number of retransmissions of said sub-transaction; and
an average packet size in said sub-transaction.

9. The method as in claim 1, comprising:
altering a condition of said IP network from a first condition to a second condition; and
comparing said metric for said sub-transaction upon said IP network under said first condition to said metric for said sub-transaction upon said IP network under said second condition.

10. The method as in claim 1, wherein said metric is calculated for a plurality of elements of said IP network.

11. The method as in claim 1, comprising:
altering a parameter of said sub-transaction;
calculating said metric for said sub-transaction having said altered parameter; and
comparing said metric for said sub-transaction to said metric for said sub-transaction having said altered parameter.

12. A system comprising a processor, said processor to:
accept an indication of a transaction on an IP network, said transaction comprising a sub-transaction; and
calculate a metric of said sub-transaction.

13. The system as in claim 12, wherein said transaction comprises a transaction on a first hierarchical level, and wherein said sub-transaction comprises a sub-transaction on a second hierarchical level, and wherein said processor is to calculate said metric for said second hierarchical level and compare said metric for said second hierarchical level with said metric for said transaction on said first hierarchical level.

14. The system as in claim 13, wherein said sub-transaction comprises a sub-sub-transaction, and wherein said processor is to calculate said metric for said sub-sub-transaction.

15. The system as in claim 12, wherein said processor is to present an indication of said sub-transaction and an indication of said metric in a hierarchical format.

16. The system as in claim 15, wherein said processor is to present said indication in a tree format.

17. An article having stored thereon instructions that when executed by a processor result in
accepting an indication of a transaction on an IP network, said transaction comprising a sub-transaction; and
calculating a metric of said sub-transaction.

18. The article as in claim 17, wherein said instructions further result in:
plotting said metric for a plurality of said sub-transactions; and
displaying a graph of said plotting.

19. The article as in claim 17, wherein said instructions further result in:
calculating said metric, said metric selected from the group consisting of:
a response time of said sub-transaction;
a network time of said sub-transaction;
a server time of said sub-transaction;
a client time of said sub-transaction;
errors in said sub-transaction;
a size in bytes of said sub-transaction;
a number of downloaded bytes in said sub-transaction;
a number of uploaded bytes in said sub-transaction;
a number of packet in flight of said sub-transaction;
an average TCP window size in said sub-transaction
a number of retransmissions of said sub-transaction; and
an average packet size in said sub-transaction.

20. The article as in claim 17, wherein said instructions further result in:
altering a condition of said IP network from a first condition to a second condition; and
comparing said metric for said sub-transaction upon said IP network under said first condition to said metric for said sub-transaction upon said IP network under said second condition.

21. The article as in claim 17, wherein said instructions further result in calculating said metric for a plurality of elements of said IP network.
